(19) United States
(12) Patent Application Publication
(10) Pub. No.: US 2011/0236811 A1
(43) Pub. Date: Sep. 29, 2011

(54) CHARGE TRANSPORT LAYER AND COATING SOLUTION FOR FORMING THE SAME

(75) Inventors: Edward F. Grabowski, Webster, NY (US); Yuhua Tong, Webster, NY (US)

(73) Assignee: XEROX CORPORATION, Norwalk, CT (US)

(21) Appl. No.: 12/731,060

(22) Filed: Mar. 24, 2010

(51) Int. Cl. G03G 5/04; H01B 1/12

(52) U.S. Cl. 430/58.8; 252/500

(57) ABSTRACT

The present embodiments are generally directed to layers that are useful in imaging apparatus members and components, for use in electrophotographic, including digital, apparatuses. More particularly, the embodiments pertain to an electrophotographic imaging member having a novel charge transport layer formed from a coating solution that is doped with specific solvents which provides a charge transport layer with superior electrical properties, and methods for making the same. In particular, the coating solution is doped with a small amount of an aprotic organic solvent.

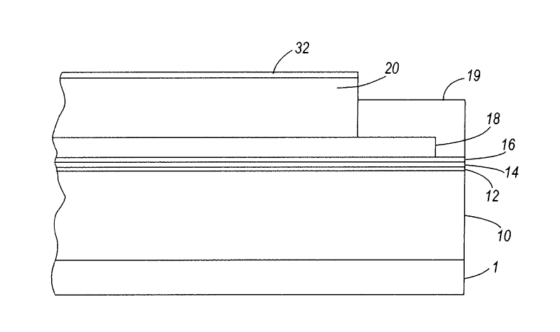

### BACKGROUND

The presently disclosed embodiments relate generally to layers that are useful in imaging apparatus members and components, for use in electrophotographic, including digital, apparatuses. More particularly, the embodiments pertain to an electrophotographic imaging member having a novel charge transport layer formed from a coating solution that is doped with specific solvents which provides a charge transport layer with superior electrical properties, and methods for making the same. In particular, the coating solution is doped with a small amount of an aprotic organic solvent. As used herein, “aprotic” means that the molecule of the solvent cannot donate hydrogen.

In electrophotographic printing, the charge retentive surface, typically known as a photoreceptor, is electrostatically charged, and then exposed to a light pattern of an original image to selectively discharge the surface in accordance therewith. The resulting pattern of charged and discharged areas on the photoreceptor form an electrostatic charge pattern, known as a latent image, conforming to the original image. The latent image is developed by contacting it with a finely divided electrostatically attractable powder known as toner. Toner is held on the image areas by the electrostatic charge on the photoreceptor surface. Thus, a toner image is produced in conformity with a light image of the original being reproduced or printed. The toner image may then be transferred to a substrate or support member (e.g., paper) directly or through the use of an intermediate transfer member, and the image affixed thereto to form a permanent record of the image to be reproduced or printed. Subsequent to development, excess toner left on the charge retentive surface is cleaned from the surface. The process is useful for light lens copying from an original or printing electronically generated or stored originals such as with a raster output scanner (ROS), where a charged surface may be imagewise discharged in a variety of ways.

To charge the surface of a photoreceptor, a contact type charging device has been used. The contact type charging device includes a conductive member which is supplied a voltage from a power source with a D.C. voltage superimposed with a A.C. voltage of no less than twice the level of the D.C. voltage. The charging device contacts the image bearing member (photoreceptor) surface, which is a member to be charged. The outer surface of the image bearing member is charged with the rubbing friction at the contact area. The contact type charging device charges the image bearing member to a predetermined potential. Typically the contact type charger is in the form of a roll charger such as that disclosed in U.S. Pat. No. 4,387,980, the relative portions thereof incorporated herein by reference. Other charging methods are further disclosed in U.S. Pat. No. 7,295,797, which is incorporated herein by reference.

Multilayered photoreceptors or imaging members have at least two layers, and may include a substrate, a conductive layer, an optional undercoat layer (sometimes referred to as a “charge blocking layer” or “hole blocking layer”), an optional adhesive layer, a photogenerating layer (sometimes referred to as a “charge generation layer,” “charge generating layer,” or “charge generator layer”), a charge transport layer, and an optional overcoating layer in either a flexible belt form or a rigid drum configuration. In the multilayer configuration, the active layers of the photoreceptor are the charge generation layer (CGL) and the charge transport layer (CTL). Enhancement of charge transport across these layers provides better photoreceptor performance. Multilayered flexible photoreceptor members may include an anti-curl layer on the backside of the substrate, opposite to the side of the electrically active layers, to render the desired photoreceptor flatness.

In organic optical-electronic devices, such as photoreceptors, organic thin film transistors, organic light-emission diodes and organic solar cells, the electrical performance of charge transport materials is usually one of the critical factors impacting the output of the devices. Charge transporting mobility and charge transporting efficiency are both very important in the selection of a charge transport material. To achieve the best charge transporting performance of the materials in a device has been a challenge. N,N′-di(3-methylphenyl)-N,N′-diphenyl-1,1′-biphenyl-4,4′-diamine (m-TBD) is a hole transporting molecular commonly used in organic photoreceptor devices. Historically, high purity of m-TBD has been considered a requirement to improve its hole transporting performance. However, making a highly purer m-TBD requires a more costly process, which leads to high cost for manufacturing photoreceptors. As m-TBD comprises up to 50% by weight in the whole photoreceptor, it is important for industrial application to optimize the process from which m-TBD is produced.

Conventional photoreceptors are disclosed in the following patents, a number of which describe the presence of light scattering particles in the undercoat layers: Yu, U.S. Pat. No. 5,660,961; Yu, U.S. Pat. No. 5,215,839; and Katayama et al., U.S. Pat. No. 5,958,638. The term “photoreceptor” or “photoconductor” is generally used interchangeably with the terms “imaging member.” The term “electrophotographic” includes “electrophotographic” and “xerographic.” The terms “charge transport molecule” are generally used interchangeably with the terms “hole transport molecule.”

### SUMMARY

According to aspects illustrated herein, there is provided a coating solution for forming a charge transport layer, comprising N,N′-di(3-methylphenyl)-N,N′-diphenyl-1,1′-biphenyl-4,4′-diamine, a polycarbonate binder, one or more coating solvents, and an aprotic organic solvent doped into the one or more coating solvents.

Another embodiment provides a process for forming a process for forming a charge transport layer, comprising preparing an organic coating solution, further comprising dissolving N,N′-di(3-methylphenyl)-N,N′-diphenyl-1,1′-biphenyl-4,4′-diamine and a polycarbonate binder into one or more coating solvents, and doping an aprotic organic solvent into the one or more coating solvents to form an organic coating solution, and coating the organic coating solution on an imaging member to form a charge transport layer.

Yet another embodiment, there is provided an imaging member comprising a substrate, a charge blocking layer disposed on the substrate, a charge generation layer disposed on the charge blocking layer, and a charge transport layer disposed on the charge generation layer, wherein the charge transport layer is formed from a coating solution comprising N,N′-di(3-methylphenyl)-N,N′-diphenyl-1,1′-biphenyl-4,4′-diamine, a polycarbonate binder, one or more coating solvents, and an aprotic organic solvent doped into the one or more coating solvents.

### BRIEF DESCRIPTION OF THE DRAWINGS

For a better understanding, reference may be made to the accompanying FIGURE.

The FIGURE is a cross-sectional view of an imaging member in a belt configuration according to the present embodiments.

### DETAILED DESCRIPTION

In the following description, reference is made to the accompanying drawings, which form a part hereof and which illustrate several embodiments. It is understood that other embodiments may be used and structural and operational changes may be made without departure from the scope of the present disclosure.

In the present embodiments, photoelectrical properties and cyclic stability of belt imaging members are improved by the addition of a small amount of dipolar aprotic solvent to the coating solution for charge transport layer, the doped aprotic solvent, remains at least partially, present in the final finished belts. N,N′-di(3-methylphenyl)-N,N′-diphenyl-1,1′-biphenyl-4,4′-diamine (m-TBD), a hole transport molecule, is used in many imaging members and its purity is critical to photo-induced discharge characteristics, especially for belt imaging members since the loading of the molecule is usually high at 50% weight. Highly pure m-TBD is desirable to achieve better performance of photoreceptor. The issue is that m-TBD with high purity always require high manufacturing cost. To figure out a way to make photoreceptor more robust against the impurity in m-TBD, or, to improve the performance of photoreceptor containing m-TBD with low purity, will significantly reduce the manufacturing cost for photoreceptor. In this effort, we found that photoreceptor performance could be improved by doping a small amount of aprotic solvents into the coating solutions for charge transport layers. In specific embodiments, the doping quantity of such dipolar aprotic solvents is from about 10 to about 500 ppm. In experiments, it was shown that doping a small quantity of ethyl acetate was found to improve residual potential and allow the belt imaging member to meet specifications for a bad lot of m-TBD containing a larger than typical quantity of impurities (>1000 ppm). In a separate experiment, another lot of m-TBD was found to have over 2000 ppm of impurity and presence of dimethylformamide (DMF). Intentional doping of additional DMF yielded better photoelectrical properties.

Hole transport material m-TBD has been used in organic photoreceptors for xerography for many years. The purity of m-TBD has been a concern for the quality of photoreceptor. The electrical properties of photoreceptor, including discharging residual voltage Vᵣ, dark decay V_{dd} and cycling stability, is heavily related to the purity of m-TBD. The hole transport layer in photoreceptor devices is a transparent solid solution with m-TBD homogeneously dissolved in polymeric binder polycarbonate. Practically, to produce 100% pure m-TBD may not be necessary. In organic photoreceptor application, if the purity of m-TBD is close to 100%, it tends to form crystals in photoreceptor devices, which may cause many electrical problems. Also, pure m-TBD usually requires costly process steps which lead to high cost in m-TBD. From industrial production, m-TBD usually contains many impurities which are extremely difficult to remove. For example, laboratory analysis has demonstrated the following impurities found in m-TBD.

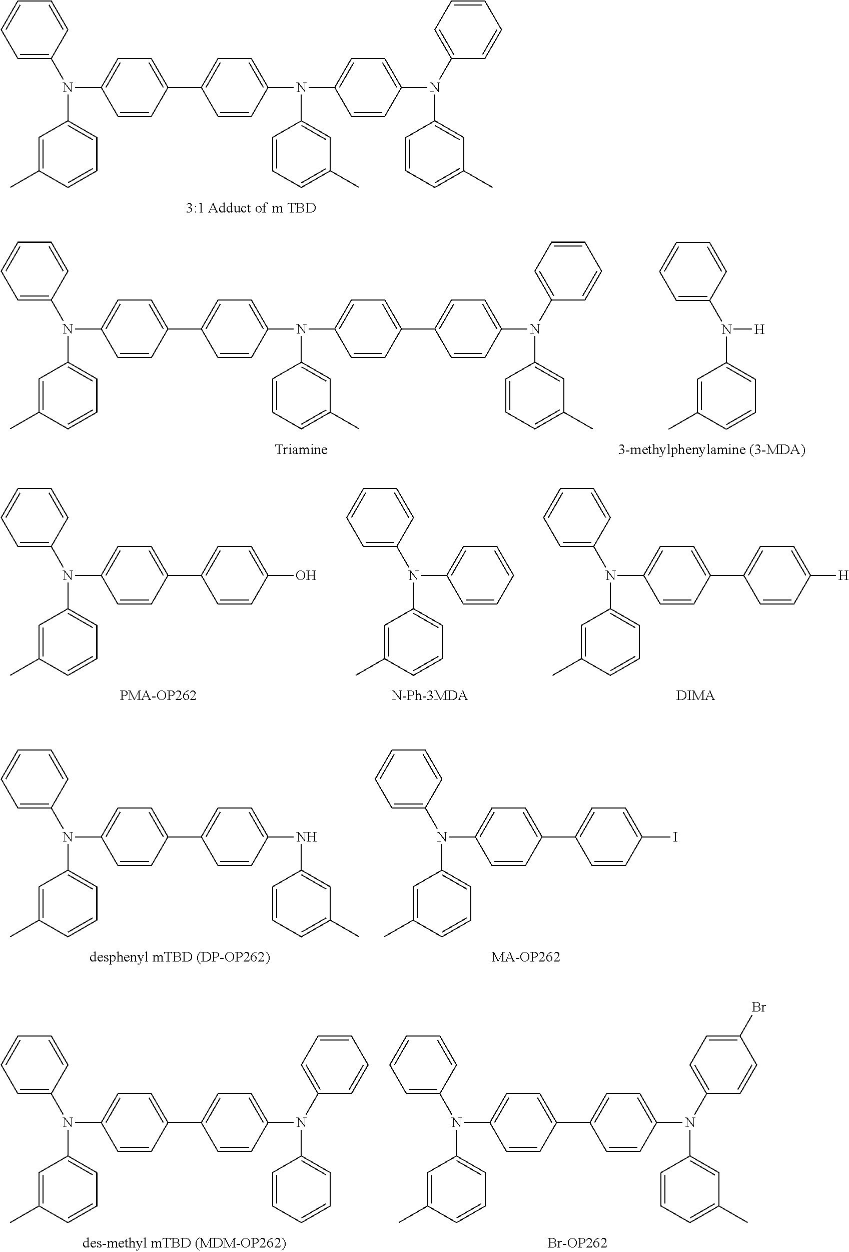

It has to be noted that not all impurities in m-TBD are harmful to photoreceptor performance, but the impurities such as DP-OP262, MA-OP262 and Br-OP262 cause electrical problems such as high Vr, high Vdd and cycling-up. As discussed above, it was found that doping a small amount of an aprotic organic solvent, such as ethyl acetate, into a coating solvent, such as methylene chloride, solved these problems caused by the impurities in m-TBD. It is believed that the interaction between the harmful impurities and the doping solvents is responsible for this outcome.

In electrophotographic reproducing or digital printing apparatuses using a photoreceptor, a light image is recorded in the form of an electrostatic latent image upon a photosensitive member and the latent image is subsequently rendered visible by the application of a developer mixture. The developer, having toner particles contained therein, is brought into contact with the electrostatic latent image to develop the image on an electrophotographic imaging member which has a charge-retentive surface. The developed toner image can then be transferred to a copy substrate, such as paper, that receives the image via a transfer member.

The exemplary embodiments of this disclosure are described below with reference to the drawings. The specific terms are used in the following description for clarity, selected for illustration in the drawings and not to define or limit the scope of the disclosure. The same reference numerals are used to identify the same structure in different figures unless specified otherwise. The structures in the figures are not drawn according to their relative proportions and the drawings should not be interpreted as limiting the disclosure in size, relative size, or location. In addition, though the discussion will address negatively charged systems, the imaging members of the present disclosure may also be used in positively charged systems.

The FIGURE shows an imaging member having a belt configuration according to the embodiments. As shown, the belt configuration is provided with an anti-curl back coating 1, a supporting substrate 10, an electrically conductive ground plane 12, an undercoat layer 14, an adhesive layer 16, a charge generation layer 18, and a charge transport layer 20. An optional overcoat layer 32 and ground strip 19 may also be included. An exemplary photoreceptor having a belt configuration is disclosed in U.S. Pat. No. 5,069,993, which is hereby incorporated by reference.

The Overcoat Layer

Other layers of the imaging member may include, for example, an optional overcoat layer 32. An optional overcoat layer 32, if desired, may be disposed over the charge transport layer 20 to provide imaging member surface protection as well as improve resistance to abrasion. In embodiments, the overcoat layer 32 may have a thickness ranging from about 0.1 micrometer to about 10 micrometers or from about 1 micrometer to about 10 micrometers, or in a specific embodiment, about 3 micrometers. These overcoating layers may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene (PTFE), and combinations thereof. Suitable resins include those described below as suitable for photogenerating layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoating layers may be continuous and have a thickness of at least about 0.1 micrometer, or no more than 10 micrometers, and in further embodiments have a thickness of at least about 2 micrometers, or no more than 6 micrometers.

The Substrate

The photoreceptor support substrate 10 may be opaque or substantially transparent, and may comprise any suitable organic or inorganic material having the requisite mechanical properties. The entire substrate can comprise the same material as that in the electrically conductive surface, or the electrically conductive surface can be merely a coating on the substrate. Any suitable electrically conductive material can be employed, such as for example, metal or metal alloy. Electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, niobium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be single metallic compound or dual layers of different metals and/or oxides.

The substrate 10 can also be formulated entirely of an electrically conductive material, or it can be an insulating material including inorganic or organic polymeric materials, such as MYLAR, a commercially available biaxially oriented polyethylene terephthalate from DuPont, or polyethylene naphthalate available as KALEDEX 2000. The substrate may have a ground plane layer 12 comprising a conductive titanium or titanium/zirconium coating. Alternatively, the substrate may have a layer of an organic or inorganic material having a semiconductive surface layer, such as indium tin oxide, aluminum, titanium, and the like, or having a conductive surface layer being made exclusively of a conductive material such as, aluminum, chromium, nickel, brass, other metals and the like. The thickness of the support substrate depends on numerous factors, including mechanical performance and economic considerations.

The substrate 10 may have a number of many different configurations, such as for example, a plate, a cylinder, a drum, a scroll, an endless flexible belt, and the like. In the case of the substrate being in the form of a belt, as shown in the FIGURE, the belt can be seamed or seamless. In embodiments, the photoreceptor herein is in a drum configuration.

The thickness of the substrate 10 depends on numerous factors, including flexibility, mechanical performance, and economic considerations. The thickness of the support substrate 10 of the present embodiments may be at least about 500 micrometers, or no more than about 3,000 micrometers, or be at least about 750 micrometers, or no more than about 2500 micrometers.

An exemplary substrate support 10 is not soluble in any of the solvents used in each coating layer solution, is optically transparent or semi-transparent, and is thermally stable up to a high temperature of about 150° C.

The Hole Blocking Layer

After deposition of the electrically conductive ground plane layer, the hole blocking layer 14 may be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer may be utilized. The hole blocking layer may include polymers such as polyvinylbutyral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl)titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl)methyl diethoxysilane, and [H₂N(CH₂)₃]CH₃Si(OCH₃)₂ (gamma-aminopropyl)methyl diethoxysilane, as disclosed in U.S. Pat. Nos. 4,338,387, 4,286,033 and 4,291,110.

General embodiments of the undercoat layer may comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Undercoat layer binder materials may include, for example, polyesters, MOR-ESTER 49,000 from Morton International Inc., VITEL PE-100, VITEL PE-200, VITEL PE-200D, and VITEL PE-222 from Goodyear Tire and Rubber Co., polyarylates such as ARDEL from AMOCO Production Products, polysulfone from AMOCO Production Products, polyurethanes, and the like.

The hole blocking layer should be continuous and have a thickness of less than about 0.5 micrometer because greater thicknesses may lead to undesirably high residual voltage. A hole blocking layer of between about 0.005 micrometer and about 1 micrometer is used because charge neutralization after the exposure step is facilitated and optimum electrical performance is achieved. A thickness of between about 0.03 micrometer and about 0.06 micrometer is used for hole blocking layers for optimum electrical behavior. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer is applied in the form of a dilute solution, with the solvent being removed after deposition of the coating by conventional techniques such as by vacuum, heating and the like. Generally, a weight ratio of hole blocking layer material and solvent of between about 0.05:100 to about 0.5:100 is satisfactory for spray coating.

The Charge Generation Layer

The charge generation layer 18 may thereafter be applied to the undercoat layer 14. Any suitable charge generation binder including a charge generating/photoconductive material, which may be in the form of particles and dispersed in a film forming binder, such as an inactive resin, may be utilized. Examples of charge generating materials include, for example, inorganic photoconductive materials such as amorphous selenium, trigonal selenium, and selenium alloys selected from the group consisting of selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions may be used where a photoconductive layer enhances or reduces the properties of the charge generation layer. Other suitable charge generating materials known in the art may also be utilized, if desired. The charge generating materials selected should be sensitive to activating radiation having a wavelength between about 400 and about 900 nm during the imagewise radiation exposure step in an electrophotographic imaging process to form an electrostatic latent image. For example, hydroxygallium phthalocyanine absorbs light of a wavelength of from about 370 to about 950 nanometers, as disclosed, for example, in U.S. Pat. No. 5,756,245.

A number of titanyl phthalocyanines, or oxytitanium phthalocyanines for the photoconductors illustrated herein are photogenerating pigments known to absorb near infrared light around 800 nanometers, and may exhibit improved sensitivity compared to other pigments, such as, for example, hydroxygallium phthalocyanine. Generally, titanyl phthalocyanine is known to have five main crystal forms known as Types I, II, III, X, and IV. For example, U.S. Pat. Nos. 5,189,155 and 5,189,156, the disclosures of which are totally incorporated herein by reference, disclose a number of methods for obtaining various polymorphs of titanyl phthalocyanine. Additionally, U.S. Pat. Nos. 5,189,155 and 5,189,156 are directed to processes for obtaining Types I, X, and IV phthalocyanines. U.S. Pat. No. 5,153,094, the disclosure of which is totally incorporated herein by reference, relates to the preparation of titanyl phthalocyanine polymorphs including Types I, II, III, and IV polymorphs. U.S. Pat. No. 5,166,339, the disclosure of which is totally incorporated herein by reference, discloses processes for preparing Types I, IV, and X titanyl phthalocyanine polymorphs, as well as the preparation of two polymorphs designated as Type Z-1 and Type Z-2.

Any suitable inactive resin materials may be employed as a binder in the charge generation layer 18, including those described, for example, in U.S. Pat. No. 3,121,006, the entire disclosure thereof being incorporated herein by reference. Organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-average molecular weight of 40,000 and is available from Mitsubishi Gas Chemical Corporation (Tokyo, Japan).

The charge generating material can be present in the resinous binder composition in various amounts. Generally, at least about 5 percent by volume, or no more than about 90 percent by volume of the charge generating material is dispersed in at least about 95 percent by volume, or no more than about 10 percent by volume of the resinous binder, and more specifically at least about 20 percent, or no more than about 60 percent by volume of the charge generating material is dispersed in at least about 80 percent by volume, or no more than about 40 percent by volume of the resinous binder composition.

In specific embodiments, the charge generation layer 18 may have a thickness of at least about 0.01 μm, or no more than about 2 μm, or of at least about 0.2 μm, or no more than about 1 μm. These embodiments may be comprised of chlorogallium phthalocyanine or hydroxygallium phthalocyanine or mixtures thereof. The charge generation layer 18 containing the charge generating material and the resinous binder material generally ranges in thickness of at least about 0.01 μm, or no more than about 5 μm, for example, from about 0.2 μm to about 3 μm when dry. The charge generation layer thickness is generally related to binder content. Higher binder content compositions generally employ thicker layers for charge generation.

The Charge Transport Layer

In a drum photoreceptor, the charge transport layer comprises a single layer of the same composition. As such, the charge transport layer will be discussed specifically in terms of a single layer 20, but the details will be also applicable to an embodiment having dual charge transport layers. The charge transport layer 20 is thereafter applied over the charge generation layer 18 and may include any suitable transparent organic polymer or non-polymeric material capable of supporting the injection of photogenerated holes or electrons from the charge generation layer 18 and capable of allowing the transport of these holes/electrons through the charge transport layer to selectively discharge the surface charge on the imaging member surface. In one embodiment, the charge transport layer 20 not only serves to transport holes, but also protects the charge generation layer 18 from abrasion or chemical attack and may therefore extend the service life of the imaging member. The charge transport layer 20 can be a substantially non-photoconductive material, but one which supports the injection of photogenerated holes from the charge generation layer 18.

The layer 20 is normally transparent in a wavelength region in which the electrophotographic imaging member is to be used when exposure is affected there to ensure that most of the incident radiation is utilized by the underlying charge generation layer 18. The charge transport layer should exhibit excellent optical transparency with negligible light absorption and no charge generation or charge trapping when exposed to a wavelength of light useful in xerography, e.g., 400 to 900 nanometers. In the case when the photoreceptor is prepared with the use of a transparent substrate 10 and also a transparent or partially transparent conductive layer 12, image wise exposure or erase may be accomplished through the substrate 10 with all light passing through the back side of the substrate. In this case, the materials of the layer 20 need not transmit light in the wavelength region of use if the charge generation layer 18 is sandwiched between the substrate and the charge transport layer 20. The charge transport layer 20 in conjunction with the charge generation layer 18 is an insulator to the extent that an electrostatic charge placed on the charge transport layer is not conducted in the absence of illumination. The charge transport layer 20 should trap minimal charges as the charge passes through it during the discharging process.

The charge transport layer 20 may include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes through. This addition converts the electrically inactive polymeric material to a material capable of supporting the injection of photogenerated holes from the charge generation layer 18 and capable of allowing the transport of these holes through the charge transport layer 20 in order to discharge the surface charge on the charge transport layer. The high mobility charge transport component may comprise small molecules of an organic compound which cooperate to transport charge between molecules and ultimately to the surface of the charge transport layer. For example, but not limited to, N,N′-diphenyl-N,N-bis(3-methyl phenyl)-1,1′-biphenyl-4,4′-diamine (TPD), other arylamines like triphenyl amine, N,N,N′,N′-tetra-p-tolyl-1,1′-biphenyl-4,4′-diamine (TM-TPD), and the like.

A number of charge transport compounds can be included in the charge transport layer, which layer generally is of a thickness of from about 5 to about 75 micrometers, and more specifically, of a thickness of from about 15 to about 40 micrometers. Examples of charge transport components are aryl amines of the following formulas/structures:

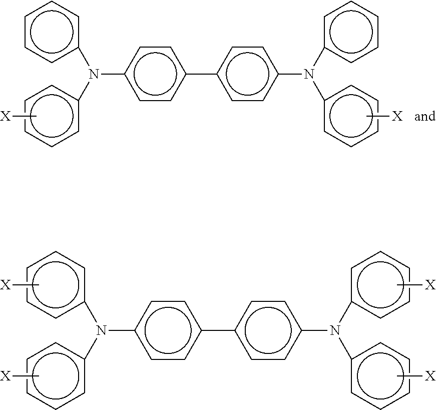

wherein X is a suitable hydrocarbon like alkyl, alkoxy, aryl, and derivatives thereof; a halogen, or mixtures thereof, and especially those substituents selected from the group consisting of Cl and CH₃; and molecules of the following formulas

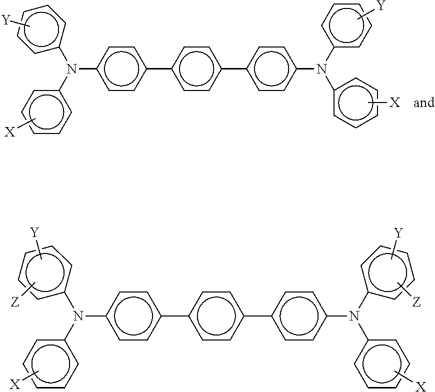

wherein X, Y and Z are independently alkyl, alkoxy, aryl, a halogen, or mixtures thereof, and wherein at least one of Y and Z are present.

Alkyl and alkoxy contain, for example, from 1 to about 25 carbon atoms, and more specifically, from 1 to about 12 carbon atoms, such as methyl, ethyl, propyl, butyl, pentyl, and the corresponding alkoxides. Aryl can contain from 6 to about 36 carbon atoms, such as phenyl, and the like. Halogen includes chloride, bromide, iodide, and fluoride. Substituted alkyls, alkoxys, and aryls can also be selected in embodiments.

Examples of specific aryl amines that can be selected for the charge transport layer include N,N′-diphenyl-N,N′-bis(alkylphenyl)-1,1-biphenyl-4,4′-diamine wherein alkyl is selected from the group consisting of methyl, ethyl, propyl, butyl, hexyl, and the like; N,N′-diphenyl-N,N′-bis(halophenyl)-1,1′-biphenyl-4,4′-diamine wherein the halo substituent is a chloro substituent; N,N′-bis(4-butylphenyl)-N,N′-di-p-tolyl-[p-terphenyl]-4,4″-diamine, N,N′-bis(4-butylphenyl)-N,N′-di-m-tolyl-[p-terphenyl]-4,4″-diamine, N,N′-bis(4-butylphenyl)-N,N′-di-o-tolyl-[p-terphenyl]-4,4″-diamine, N,N′-bis(4-butylphenyl)-N,N′-bis-(4-isopropylphenyl)-[p-terphenyl]-4,4″-diamine, N,N′-bis(4-butylphenyl)-N,N′-bis-(2-ethyl-6-methylphenyl)-[p-terphenyl]-4,4″-diamine, N,N′-bis(4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4″-diamine, and the like. Other known charge transport layer molecules may be selected in embodiments, reference for example, U.S. Pat. Nos. 4,921,773 and 4,464,450, the disclosures of which are totally incorporated herein by reference.

Examples of the binder materials selected for the charge transport layers include components, such as those described in U.S. Pat. No. 3,121,006, the disclosure of which is totally incorporated herein by reference. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments, the charge transport layer, such as a hole transport layer, may have a thickness of at least about 10 μm, or no more than about 40 μm.

Examples of components or materials optionally incorporated into the charge transport layers or at least one charge transport layer to, for example, enable improved lateral charge migration (LCM) resistance include hindered phenolic antioxidants such as tetrakis methylene (3,5-di-tert-butyl-4-hydroxy hydrocinnamate) methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R, NR, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd.), TINUVIN® 144 and 622LD (available from Ciba Specialties Chemicals), MARK™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layer is from about 0 to about 20, from about 1 to about 10, or from about 3 to about 8 weight percent.

The charge transport layer should be an insulator to the extent that the electrostatic charge placed on the hole transport layer is not conducted in the absence of illumination at a rate sufficient to prevent formation and retention of an electrostatic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used.

Drying of the deposited coating may be effected by any suitable conventional technique such as oven drying, infra red radiation drying, air drying and the like. The thickness of the charge transport layer after drying is from about 10 μm to about 40 μm or from about 12 μm to about 36 μm for optimum photoelectrical and mechanical results. In another embodiment the thickness is from about 14 μm to about 36 μm.

In the present embodiments, there is provided a process for making a charge transport layer that exhibits superior electrical properties without the need for using high purity pure hole transport material like m-TBD. By doping a small amount of an organic solvent into the coating solution, the electrical properties of the photoreceptor devices are dramatically improved, even with less pure m-TBD. Thus, the present disclosure teaches a practical and efficient process by which charge transport materials achieve better performance in optical-electronic devices.

In the present embodiments, the process for forming a charge transport layer comprises preparing an organic coating solution and coating the organic coating solution on an imaging member to form a charge transport layer. The organic coating solution is made by dissolving N,N′-di(3-methylphenyl)-N,N′-diphenyl-1,1′-biphenyl-4,4′-diamine and a polycarbonate binder into one or more coating solvents, and doping an aprotic organic solvent into the one or more coating solvents to form an organic coating solution.

The aprotic doping solvent should have a boiling point temperature higher than that of the main coating solvents. The doping level of the organic solvent should be less than about 1% of the total coating solvents, and in specific embodiments, from about 1,000 to about 1 ppm, or from about 500 ppm to about 10 ppm, or from about 100 ppm to about 20 ppm, to obtain superior image quality. The aprotic solvent has a boiling point greater than the coating solution, or a boiling point of from about 50° C. to about 400° C., or from about 60° C. to about 300° C., or from about 65° C. to about 200° C. An aprotic doping solvent such as ethyl acetate, dimethylformamide (DMF), tetrahydrofuran (THF), butanone, butyl acetate, N-methylpyrrolidinone, dimethylacetamide, toluene, xylene, chlorobenzene, and mixtures thereof and the like, is more suitable in organic photoreceptor application although there is a wide range of suitable doping solvents. In specific embodiments, with ethyl acetate or DMF doped methylene chloride as the coating solvent, m-TBD has demonstrated very good electrical properties in photoreceptors.

Thus, the present embodiments provide for a coating solution for forming a charge transport layer, comprising N,N′-di(3-methylphenyl)-N,N′-diphenyl-1,1′-biphenyl-4,4′-diamine, a polycarbonate binder, one or more coating solvents, and an aprotic organic solvent doped into the one or more coating solvents. In embodiments, the one or more coating solvents is selected from the group consisting of methylene chloride, toluene, methyl ethyl ketone, chlorobenzene, xylene, and mixtures thereof and the like. In embodiments, the aprotic organic solvent is selected from the group consisting of ethyl acetate, N,N-dimethyl formamide, tetrahydrofuran, butanone, butyl acetate, N-methylpyrrolidinone, dimethylacetamide, toluene, xylene, chlorobenzene, and mixtures thereof. In further embodiments, the N,N′-di(3-methylphenyl)-N,N′-diphenyl-1,1′-biphenyl-4,4′-diamine is present in the coating solution in an amount of from about 1 percent to about 50 percent or from about 2 to about 40 by weight of the total weight of the coating solution.

In yet other embodiments, there is provided an imaging member comprising a substrate, a charge blocking layer disposed on the substrate, a charge generation layer disposed on the charge blocking layer, and a charge transport layer disposed on the charge generation layer, wherein the charge transport layer is formed from a coating solution comprising N,N′-di(3-methylphenyl)-N,N′-diphenyl-1,1′-biphenyl-4,4′-diamine, a polycarbonate binder, one or more coating solvents, and an aprotic organic solvent doped into the one or more coating solvents. In specific embodiments, the imaging member has Vr of from about 0 to about 200, or from about 10 to about 100. Despite impurities in the m-TBD, the imaging member of the present embodiments exhibits much lower Vr than that of an imaging member not doped with the aprotic organic solvent. Likewise, despite impurities in the m-TBD, the imaging member of the present embodiments exhibits much lower Vdd than that of an imaging member not doped with the aprotic organic solvent. The imaging member of the present embodiments also exhibits little to no cycling-up despite m-TBD impurities.

The Adhesive Interfacial Layer

An optional separate adhesive interfacial layer may be provided in certain configurations, such as for example, in flexible web configurations. In the embodiment illustrated in the FIGURE, the interfacial layer would be situated between the blocking layer 14 and the charge generation layer 18. The interfacial layer may include a copolyester resin. Exemplary polyester resins which may be utilized for the interfacial layer include polyarylatepolyvinylbutyrals, such as ARDEL POLYARYLATE (U-100) commercially available from Toyota Hsutsu Inc., VITEL PE-100, VITEL PE-200, VITEL PE-200D, and VITEL PE-222, all from Bostik, 49,000 polyester from Rohm Hass, polyvinyl butyral, and the like. The adhesive interfacial layer may be applied directly to the hole blocking layer 14. Thus, the adhesive interfacial layer in embodiments is in direct contiguous contact with both the underlying hole blocking layer 14 and the overlying charge generator layer 18 to enhance adhesion bonding to provide linkage. In yet other embodiments, the adhesive interfacial layer is entirely omitted.

Any suitable solvent or solvent mixtures may be employed to form a coating solution of the polyester for the adhesive interfacial layer. Solvents may include tetrahydrofuran, toluene, monochlorobenzene, methylene chloride, cyclohexanone, and the like, and mixtures thereof. Any other suitable and conventional technique may be used to mix and thereafter apply the adhesive layer coating mixture to the hole blocking layer. Application techniques may include spraying, dip coating, roll coating, wire wound rod coating, and the like. Drying of the deposited wet coating may be effected by any suitable conventional process, such as oven drying, infra red radiation drying, air drying, and the like.

The adhesive interfacial layer may have a thickness of at least about 0.01 micrometers, or no more than about 5 micrometers after drying. In embodiments, the dried thickness is from about 0.03 micrometers to about 1 micrometer.

The Anti-Curl Back Coating Layer

The anti-curl back coating 1 may comprise organic polymers or inorganic polymers that are electrically insulating or slightly semi-conductive. The anti-curl back coating provides flatness and/or abrasion resistance.

Anti-curl back coating 1 may be formed at the back side of the substrate 2, opposite to the imaging layers. The anti-curl back coating may comprise a film forming resin binder and an adhesion promoter additive. The resin binder may be the same resins as the resin binders of the charge transport layer discussed above. Examples of film forming resins include polyacrylate, polystyrene, bisphenol-based polycarbonate, poly(4,4′-isopropylidene diphenyl carbonate), 4,4′-cyclohexylidene diphenyl polycarbonate, and the like. Adhesion promoters used as additives include 49,000 (du Pont), Vitel PE-100, Vitel PE-200, Vitel PE-307 (Goodyear), and the like. Usually from about 1 to about 15 weight percent adhesion promoter is selected for film forming resin addition. The thickness of the anti-curl back coating is at least about 3 micrometers, or no more than about 35 micrometers, or about 14 micrometers.

In addition, in the present embodiments using a belt configuration, the charge transport layer may consist of a single pass charge transport layer or a dual pass charge transport layer (or dual layer charge transport layer) with the same or different transport molecule ratios. In these embodiments, the dual layer charge transport layer has a total thickness of from about 10 μm to about 40 μm. In other embodiments, each layer of the dual layer charge transport layer may have an individual thickness of from 2 μm to about 20 μm. Moreover, the charge transport layer may be configured such that it is used as a top layer of the photoreceptor to inhibit crystallization at the interface of the charge transport layer and the overcoat layer. In another embodiment, the charge transport layer may be configured such that it is used as a first pass charge transport layer to inhibit microcrystallization occurring at the interface between the first pass and second pass layers.

Various exemplary embodiments encompassed herein include a method of imaging which includes generating an electrostatic latent image on an imaging member, developing a latent image, and transferring the developed electrostatic image to a suitable substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

The following examples demonstrate the impact of doping solvent ethyl acetate and N,N-dimethyl formamide (DMF) into coating solvent methylene chloride on the electrical properties of photoreceptor devices.

### Example 1

One lot of m-TBD from Fujifilm Finechemicals Co., Ltd located at Kanagawa, Japan, had impurity about 1376 ppm as determined by LC/UV-Vis. This m-TBD caused high Vᵣ and high V_{dd} issues in the photoreceptor coating plant. In effort to solve the problems, ethyl acetate was doped into the coating solution. The formulation for charge transport layer is listed in Table 1.

TABLE 1
Formulation for Charge Transport Layer with m-TBD

| | | Polycarbonate, | Methylene | Ethyl Acetate, |
|---|---|---|---|---|
| Sample # | m-TBD, g | g | Chloride, g | ppm |
| #1 | 15.0 | 15.0 | 170 | 57 |
| #2 | 15.0 | 15.0 | 170 | 48 |

For the CTL formulation, sample #1 and #2 had small difference in ethyl acetate doping level. The CTL solutions were applied by 4.5-mil bar on substrate with up to CGL coated in the Xerox AMAT Plant (XAP). As seen in Table 2, the electrical properties of these two samples demonstrated a big difference in V_{dd} and Vᵣ with V_{dd} and Vᵣ being reduced for the sample with a higher doping level. This results also demonstrated that ethyl acetate doping in CTL can be very effective resolving impurities in m-TBD.

TABLE 2
Electrical Properties of Photoreceptor Devices with Doped CTL

| | | S, | | |
|---|---|---|---|---|
| Sample # | V₀, volt | V cm²/ergs | Vᵣ volt | V_{dd} volt |
| #1 | 796 | 380 | 36.1 | 32.0 |
| #2 | 794 | 323 | 53.9 | 73.9 |

Where V₀ is the initial charging voltage; S is initial slope of the PIDC curve and a measure of the sensitivity; Vᵣ is the discharging residual voltage, and V_{dd} is the dark decay.

### Example 2

In another laboratory experiment, another lot m-TBD was evaluated by DMF doping. This m-TBD had impurity about 2070 ppm. The CTL formulations are listed in Table 3.

TABLE 3
Formulation for Charge Transport Layer with m-TBD

| | | Polycarbonate, | methylene | |
|---|---|---|---|---|
| Sample # | m-TBD, g | g | chloride₂, g | DMF, ppm |
| #3 | 15.0 | 15.0 | 170 | 335 |
| #4 | 15.0 | 15.0 | 170 | 303 |

The CTL solutions were applied by 4.5-mil bar on substrate with up to CGL coated in XAP. Coated photoreceptor devices were dried at 120° C. for 1 minute. With high DMF doping level, the electrical properties of these two samples demonstrated a substantial difference in V_{dd} and Vᵣ in these two samples, with both V_{dd} and Vᵣ being reduced at the higher doping level. As can be seen from Table 4, this m-TBD had much higher impurity level than the previous m-TBD. Thus, it may be reasonable to require higher solvent doping level. It may also be that DMF is not as efficient as ethyl acetate for this electrical property improvement in organic photoreceptor devices.

TABLE 4
Electrical Properties of Photoreceptor Devices with Doped CTL

| | | S, | | |
|---|---|---|---|---|
| Sample # | V₀, volt | V cm²/ergs | Vᵣ, volt | V_{dd}, volt |
| #3 | 797 | 358 | 36.4 | 29.1 |
| #4 | 796 | 328 | 59.9 | 48.3 |

Where V₀ is the initial charging voltage; S is the initial slope of the PIDC curve and a measure of sensitivity; Vᵣ is the discharging residual voltage, and V_{dd} id the dark decay. Thus, the present disclosure teaches that, by doping coating solvents such as ethyl acetate and DMF into the charge transport layer coating solution, the electrical properties of the resulting photoreceptor devices were significantly improved. It is further demonstrated that ethyl acetate doping was more efficient than DMF. The doping level of the solvent needed is less than 1% of all coating solvents in the coating solution, and more specifically, from about 500 ppm to about 10 ppm. The doping level may also be further optimized depending on the impurity level in m-TBD and the efficiency of the selected doping solvents.

All the patents and applications referred to herein are hereby specifically, and totally incorporated herein by reference in their entirety in the instant specification.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A coating solution for forming a charge transport layer, comprising:
N,N′-di(3-methylphenyl)-N,N′-diphenyl-1,1′-biphenyl-4,4′-diamine;
a polycarbonate binder;
one or more coating solvents; and
an aprotic organic solvent doped into the one or more coating solvents.

2. The coating solution of claim 1, wherein the aprotic organic solvent is present in the coating solution in an amount of less than 1 percent by weight of the total weight of the coating solvents.

3. The coating solution of claim 1, wherein the aprotic organic solvent is present in the coating solution in an amount of from about 500 ppm to about 10 ppm.

4. The coating solution of claim 1, wherein the aprotic organic solvent has a boiling point of from about 50° C. to about 400° C.

5. The coating solution of claim 1, wherein the one or more coating solvents is selected from the group consisting of methylene chloride, toluene, methyl ethyl ketone, chlorobenzene, xylene, and mixtures thereof.

6. The coating solution of claim 1, wherein the aprotic organic solvent is selected from the group consisting of ethyl acetate, dimethylformamide (DMF), tetrahydrofuran (THF), butanone, butyl acetate, N-methylpyrrolidinone, dimethylacetamide, toluene, xylene, chlorobenzene, and mixtures thereof.

7. The coating solution of claim 1, wherein the N,N′-di(3-methylphenyl)-N,N′-diphenyl-1,1′-biphenyl-4,4′-diamine is present in the coating solution in an amount of from about 1 percent to about 50 percent by weight of the total weight of the coating solution.

8. The coating solution of claim 1, wherein a boiling point of the aprotic organic solvent is higher than that of the one or more coating solvents.

9. A process for forming a charge transport layer, comprising
preparing an organic coating solution, further comprising
dissolving N,N′-di(3-methylphenyl)-N,N′-diphenyl-1,1′-biphenyl-4,4′-diamine and a polycarbonate binder into one or more coating solvents; and
doping an aprotic organic solvent into the one or more coating solvents to form an organic coating solution; and
coating the organic coating solution on an imaging member to form a charge transport layer.

10. The process of claim 9, wherein the aprotic organic solvent is present in the coating solution in an amount of less than 1 percent by weight of the total weight of the coating solvents.

11. The process of claim 9, wherein the aprotic organic solvent is present in the coating solution in an amount of from about 500 ppm to about 10 ppm.

12. The process of claim 9, wherein the one or more coating solvents is selected from the group consisting of methylene chloride, toluene, methyl ethyl ketone, chlorobenzene, xylene, and mixtures thereof.

13. The process of claim 9, wherein the one or more coating solvents is selected from the group consisting of ethyl acetate, dimethylformamide (DMF), tetrahydrofuran (THF), butanone, butyl acetate, N-methylpyrrolidinone, dimethylacetamide, toluene, xylene, chlorobenzene, and mixtures thereof.

14. An imaging member comprising:
a substrate;
a charge blocking layer disposed on the substrate;
a charge generation layer disposed on the charge blocking layer; and
a charge transport layer disposed on the charge generation layer, wherein the charge transport layer is formed from a coating solution comprising
N,N′-di(3-methylphenyl)-N,N′-diphenyl-1,1′-biphenyl-4,4′-diamine;
a polycarbonate binder;
one or more coating solvents; and
an aprotic organic solvent doped into the one or more coating solvents.

15. The imaging member of claim 14, wherein the charge transport layer has a thickness of from about 10 to about 40 micrometers.

16. The imaging member of claim 14, wherein the aprotic organic solvent is present in the coating solution in an amount of less than 1 percent by weight of the total weight of the coating solvents.

17. The imaging member of claim 14, wherein the aprotic organic solvent is present in the coating solution in an amount of from about 500 ppm to about 10 ppm.

18. The imaging member of claim 14, wherein the one or more coating solvents is selected from the group consisting of methylene chloride, toluene, methyl ethyl ketone, chlorobenzene, xylene, and mixtures thereof.

19. The imaging member of claim 14, wherein the one or more coating solvents is selected from the group consisting of ethyl acetate, dimethylformamide (DMF), tetrahydrofuran (THF), butanone, butyl acetate, N-methylpyrrolidinone, dimethylacetamide, toluene, xylene, chlorobenzene, and mixtures thereof.

20. The imaging member of claim 14 having lower cycling-up than that of an imaging member not doped with the aprotic organic solvent.
